(19) United States
(12) Patent Application Publication
(10) Pub. No.: US 2016/0323718 A1
(43) Pub. Date: Nov. 3, 2016

(54) Mobile Accident Processing System and Method

(71) Applicant: Better Mousetrap, LLC, Denver, CO (US)

(72) Inventor: Brendan B. Dawson, Littleton, CO (US)

(21) Appl. No.: 15/141,358

(22) Filed: Apr. 28, 2016

Related U.S. Application Data
(63) Continuation-in-part of application No. 14/490,915, filed on Sep. 19, 2014, now abandoned.

(51) Int. Cl. H04W 4/04; G09B 19/14; G09B 7/00; H04W 4/22; H04L 29/12

(52) U.S. Cl. CPC H04W 4/046; H04W 4/22; H04L 61/1594; G09B 7/00; G09B 19/14; H04W 88/08

(57) ABSTRACT

A mobile accident processing system and method. An example system includes a mobile device configured to issue a notification of an accident involving a vehicle. The example system also includes a base station device configured to respond to the notification and test at least one condition associated with the accident. The base station assesses circumstances of the accident based on testing the at least one condition and determines whether an impairment test is required.

### PRIORITY CLAIM AND INCORPORATION BY REFERENCE

This application is a continuation-in-part, and claims benefits from, of U.S. patent application Ser. No. 14/490,915 entitled “Mobile Accident Processing System and Method”, filed Sep. 19, 2014, which claims the benefit of U.S. Provisional Patent Application No. 61/880,495 titled “Mobile Accident Kit” of Brendan Dawson filed on Sep. 20, 2013, both hereby incorporated by reference in their entirety for all purposes.

### BACKGROUND

In the United States, a police reported accident involving a commercial vehicle occurs every 1.6 minutes. Annual expenses occurring from commercial vehicle crashes are estimated by the Federal Highway Safety Administration to be around eighty-seven billion dollars (FHWA, Highway Statistics 2010 and Highway Statistics 2011, Table VM-1). Although accidents involving personal vehicles are about sixteen times as common as commercial vehicle accidents, due to their size, weight, and commercial status, the motor carriers who operate larger vehicles and the companies employing them are often the target of liability litigation.

Commercial fleet operators must investigate accidents carefully in order to protect their business interests. An important factor in creating a good investigation report is having accurate, quality, and contemporaneous information from the scene. Management and/or administrating personnel rarely witness the crash, and thus have to rely on the driver to carefully and accurately document the accident scene. However, the driver may not have prior experience with processing the scene of an accident and/or may be emotionally distracted and thus unable to carefully and/or accurately document the accident scene.

### BRIEF DESCRIPTION OF THE DRAWINGS

FIG. 1 is a high-level illustration of an example networked system which may be implemented by the mobile accident processing system and method.

FIGS. 2A-B is are illustrations of example screen output by the mobile accident processing system and method, illustrating an initiator sequence.

FIG. 3 is a flowchart illustrating example operations to initiate accident processing and a training module for accident processing.

FIG. 4 is an illustration of an example screen output by the mobile accident processing system and method, illustrating an example aspect of accident processing.

FIGS. 5A-B is are illustrations of example screen output by the mobile accident processing system and method, illustrating another example aspect of accident processing.

FIG. 6 is a flowchart illustrating example operations of a logic module to test for conditions and assess circumstances following an accident in which a driver may be subject to an impairment test.

FIG. 7 is a flowchart illustrating example operations of a system.

FIG. 8 is an example logic operation chart of the selection of a type of vehicle user interface.

FIG. 9 is an example of a YES/NO/OTHER type user interface.

FIG. 10 is an example of a MULTIPLE CHOICE type user interface.

FIG. 11 is an example of a NUMBER RANGE type user interface.

FIG. 12 is an example of a DIAGRAM type user interface.

FIG. 13 is an example of a INFORMATIONAL type user interface.

FIG. 14 is an example of a SLIDESHOW type user interface.

FIG. 15 is an example of an IMAGE type user interface.

FIG. 16 is an example of a VOICE RECORDING type user interface.

FIG. 17 is an example of a SIGNATURE type user interface.

FIG. 18 is an example of a PAGE/PAGE GROUP type user interface.

FIG. 19 is an example of a VEHICLE PAGE QUESTION type user interface.

FIG. 20 is an example of a NOTIFICATION type user interface.

FIG. 21 is an example of a PAGE GROUP type user interface.

FIG. 22 is an example of another PAGE GROUP type user interface.

### DETAILED DESCRIPTION

The commercial carrier industry is often subject to unnecessary litigation and/or left defending an unfavorable position in litigation and/or settlement following an accident.

The commercial vehicle driver has some very specific responsibilities while attending to an accident scene. He has to secure the scene and alert oncoming traffic using reflective warning triangles and emergency flashers; assist those in need to the best of his ability; turn his engine off to protect “black box” engine data; and, most importantly, cooperate with authorities and other parties without causing self-incrimination.

Furthermore, in order to place any vehicle operator in a defensible position, the driver has to gather as much information as possible in order to assist in future accident investigation.

Meanwhile, the company administrator also has important responsibilities. That person has to organize a detailed accident report and investigation for their company counsel and insurance company.

In addition, under certain circumstances following an accident a driver must be subject to an alcohol test within a predetermined time (e.g., eight hours) of the accident and a drug test within another predetermined time (e.g., 32 hours) post-accident. If the company cannot achieve this, then they must document efforts to have done so.

A mobile accident processing system and method is described herein, such as it may be implemented in a tool (or tools) that help the commercial carrier, with the assistance of the driver (or other personnel) train for in advance of an accident, and in the event of an accident create a comprehensive and accurate accident report. In an example, the tool may relay information to administrative personnel of the commercial carrier, and confirm that all data is collected properly. In an example, the tool may also relay information in real-time to first responders, e.g., to receive medical and/or mechanical help if needed.

The mobile accident processing system and method may be embodied at least in part as an application executable on a mobile device and communicatively coupled with program code executing on a base station (e.g., a host computer, such as but not limited to a server computer or other remote computer system). In an example, the system is a computer program product embodied as computer-readable instructions stored on a non-transient computer-readable media and executable by a processor to process an accident. Processing the accident may include receiving notification of an accident involving at least a commercial carrier. Processing the accident may also include testing at least one condition associated with the accident. Processing the accident may also include assessing circumstances of the accident based on testing the at least one condition to determine whether an impairment test is required. In an example, assessing circumstances includes. but is not limited to, determining if at least one of the following conditions exist: Condition 1: the accident involves a fatality; Condition 2: if there has been an injury requiring treatment away from the scene (e.g., an ambulance ride), and a traffic citation is issued to a commercial carrier driver; and Condition 3: a vehicle is required to be towed and a traffic citation is issued to a commercial carrier driver.

In an example, the computer program product is executable by the processor to start a timer upon receiving notification of the accident, the timer identifying a time requirement for obtaining the impairment test.

In an example, the computer program product is executable by the processor to instruct a commercial carrier driver to complete the impairment test.

In an example, the computer program product is executable by the processor to document the circumstances when an impairment test is determined to be unnecessary.

In an example, the computer program product is executable by the processor to receive signals from a global positioning device, and associate at least one location-specific condition with the circumstances. The at least one location-specific condition may be, by way of non-limiting illustration a weather condition, a road condition, and/or a traffic condition.

In an example, the computer program product is executable by the processor to preserve information on a black-box of a vehicle involved in the accident.

In an example, the computer program product is executable by the processor to instruct a user on a step-by-step basis to collect information about the accident.

In an example, the computer program product is executable by the processor to provide a training module to a commercial carrier driver.

The system may be implemented to communicate with emergency services in the case of a vehicle accident, communicate with a remote administrator about the vehicle accident, process data pertaining to the accident, determine one or more next step based on the data received, and prompt the user to take the next step to create a vehicle accident report.

In an example, the application may be implemented by a mobile device including, but not limited to phones, tablets, laptops, wearable devices, global positioning receivers, voice recorders, or any other computing devices. Further, the application may contain instructions to send and receive signals from a global positioning satellite, cellular telephone triangulation, or other methods and systems to determine a location of the mobile device. The data input into the application by the user may be viewable by the remote administrator. The example application may further contain picture, text, video, or voice data aimed at educating a user on protocols surrounding vehicle accidents.

Before continuing, it is noted that as used herein, the term “commercial carrier” is used herein to refer to any transportation and/or delivery company (government and/or private), including but not limited to the trucking and freight industry which delivers goods, and municipal bus, school bus, taxi cab and shuttle services which transport people, and any other use of government and/or private (albeit, non-personal) vehicles such as, e.g., trains. In an example, the term “commercial carrier” includes but is not limited to “commercial Motor Vehicle” as defined in the current 49 C.F.R. 390.5 as “any self-propelled or towed motor vehicle used on a highway in interstate commerce to transport passengers or property when the vehicle: (1) Has a gross vehicle weight rating or gross combination weight rating, or gross vehicle weight or gross combination weight, of 4,536 kg (10,001 pounds) or more, whichever is greater; or (2) Is designed or used to transport more than 8 passengers (including the driver) for compensation; or (3) Is designed or used to transport more than 15 passengers, including the driver, and is not used to transport passengers for compensation; or (4) Is used in transporting material found by the Secretary of Transportation to be hazardous under 49 U.S.C. 5103 and transported in a quantity requiring placarding under regulations prescribed by the Secretary under 49 CFR, subtitle 13, chapter I, subchapter C.” Driver lies driven information may be found from the Federal Motor Carrier Department, as is accident data for a commercial carrier.

The term “accident” is used herein to refer to any collision on a roadway or other point of passage, whether the collision is between a vehicle and at least one other vehicle and/or a vehicle and another object, and regardless of fault or cause. Accident also refers to roll over, fire, immersion, jackknife, cargo loss, fall from vehicle and falling object, and other accidents.

Furthermore, the terms “include,” “includes” and “including” mean, but is not limited to, “include,” “includes” or “including” in addition to “include at least,” “includes at least” and/or “including at least.” The term “based on” means “based on” and “based at least in part on.”

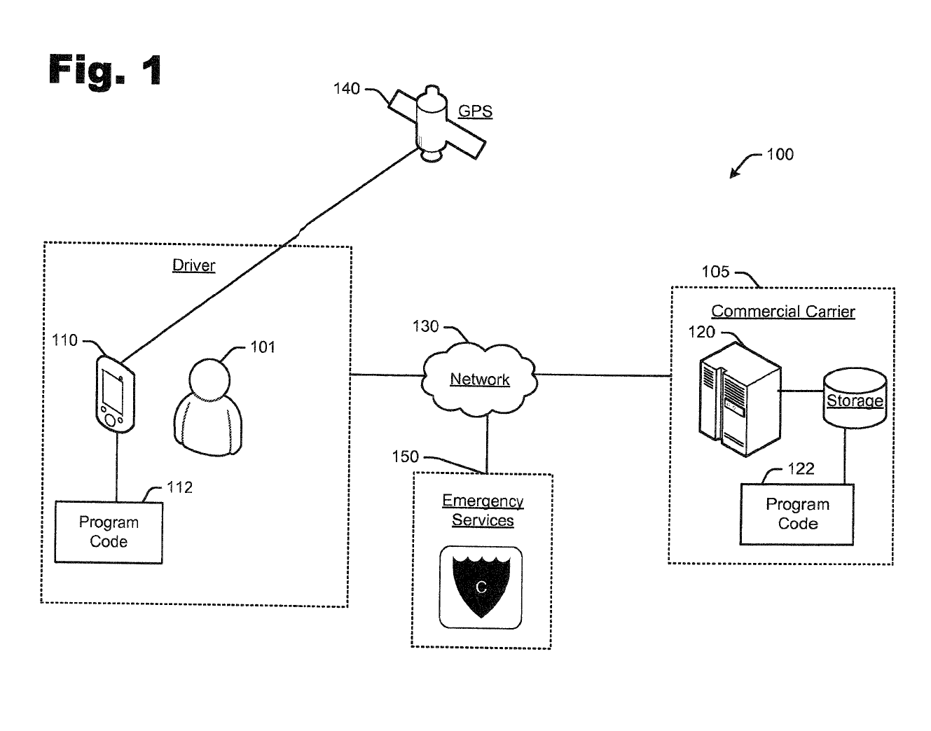

FIG. 1 is a high-level illustration of an example networked system which may be implemented by the mobile accident processing system 100 and method. The mobile accident processing system 100 and method may be implemented in a computing environment accessed by a driver 101 for a commercial carrier. In an example, the driver 101 carries at least one user device or mobile device 110, such as but not limited to a mobile phone or “smart” phone, wearable device, a tablet or other computing device (e.g., a laptop computer or embedded device in the driver's vehicle). The mobile device 110 may execute program code 112 (e.g., a mobile phone “app”). The mobile device 110 may be communicatively coupled with a server or host computer 120 at the commercial carrier facility 105 via network 130. The mobile device 110 may also be communicatively coupled with a location service 140 (e.g., a GPS service) and/or emergency services 150 (e.g., police, EMT, or other first responders). Mobile device 110 may also include other services, as on-board (e.g., on the mobile device 110 such as but not limited to a built-in camera, voice recorder, and voice recognition module) and/or remote service(s) (e.g., the Internet, corporate databases, etc.), an accelerometer, and GPS, etc.

The host computer 120 may be implemented with any of a wide variety of computing devices, such as, but not limited to, stand-alone desktop/laptop/netbook computers, workstations, server computers, blade servers, and appliances (e.g., devices dedicated to providing a service), to name only a few examples. The host computer 120 may execute program code 122.

Each of the computing devices (e.g., mobile device 110 and host computer 120) may include memory, storage, and a degree of data processing capability at least sufficient to manage a communications connection either directly with one another or indirectly (e.g., via a network). The computing devices are also configured with sufficient processing capability to execute the program code described herein.

It is noted that the components shown and described herein are provided only for purposes of illustration of an example operating environment, and are not intended to limit implementation to any particular system

The program code 112 on the mobile device 112 may execute in combination with the program code 122 executing on host computer 120 to provide the services described herein. In an example, the program code 112 and/or 122 may be part of a cloud-based service, wherein the program code is executed on at least one local computing device, but having access to the service via a cloud computing platform.

In an example, the program code may be implemented in machine-readable instructions (such as but not limited to, software or firmware). The machine-readable instructions may be stored on a non-transient computer readable medium and are executable by one or more processor to perform the operations described herein. However, the operations described herein are not limited to any specific implementation with any particular type of program code.

During operation, the program code may execute the function of the architecture of machine readable instructions as self-contained modules. These modules can be integrated within a self-standing tool, or may be implemented as agents that run on top of an existing program code. Program code which implements aspects of the system and method can be better understood with reference to the following discussion of various example functions.

Before continuing, it should be noted that the examples described above are provided for purposes of illustration, and are not intended to be limiting. Other devices and/or device configurations may be utilized to carry out the operations described herein.

An example system may consist of two main components; the end user application, installed on a hand held mobile device, and the administrative web portal, installed on a server. The administrative portal may be customized to suit individual clients, vertical market segments or even whole new horizontal markets. The application on the user device may be ‘remotely’ launched in the field by a wearable device, such as a smart watch, synced with the mobile device, so that the incident gets reported, and all emergency contacts are notified, by initiation from the wearable device or other remote device, even when the mobile device (phone, tablet, etc.) is not immediately accessible.

The administrative portal site may be written in the PHP code base, a server-side scripting language designed for web development but also used as a general-purpose programming language. PHP code can be simply mixed with HTML code, or it can be used in combination with various templating engines and web frameworks. PHP code is usually processed by a PHP interpreter, which is usually implemented as a web server's native module or a Common Gateway Interface (CGI) executable. The mobile application may be composed primarily in the Javascript language. Also included is the mobile report form builder engine. It will be appreciated that many different programming languages, techniques and structures may be used without straying from the spirit and scope of this disclosure.

According to an example system, there are three levels of access privilege within the system; End User, Customer Administrator and Super Administrative.

END USER: The end user is typically the driver. The end user may install the application on their mobile device using the App Store or Google Play for iOS or Android devices or the like. Upon opening the app the End User is prompted for a log in ID and password that will be provided by the Customer Administrator.

The mobile web pages will be installed natively on the end users mobile device so that the application will be able to prompt the user with questions, receive answers and store data on the device quickly and even if the device is not connected to the network. The training videos will be hosted on the network and available for streaming.

Once the application is installed on the mobile device the user will have access to the application at any time. The training videos will be available as long as there is an adequate network connection. The training may include a quiz to insure the user has completed and understood the training. The records of the training may be kept on a server in the event it is requested.

When the end user deploys system via the software on the user device, the application launches a series of questions, the answers to which will determine the severity of the crash, coach the driver for appropriate behavior, and gather information about the situation. The questions and answers are governed by rules that are more clearly explained in section SUPER ADMINISTRATOR.

CLIENT ADMINISTRATOR: The client administrator, typically the safety manager from the trucking company, will access the customer portal through an internet browser. They will access the portal from a main website. From there they will establish and pay for their account. At that time they will be required enter the company name, address and phone number. They will also enter the names, email addresses and cell numbers of all contacts on their notification list as well as the method of contact, either text, email or both. Optionally they will enter their DOT number, MC Number or PUC number as appropriate.

The client administrator may also enter the number of vehicles from each of the twelve classes that they operate, their operation classification, range of operation, cargo type, and whether they are a passenger or hazardous materials carrier. From their account the customer administrator will have access to and manage four types of data; their company data, their account subscription, their user base, and their accident reports.

From the users tab the client administrator or customer can choose to add end users one at a time or can import a .CSV file from their own data base and map the fields to their proper addresses. Also included may be an application programming interface (API) that will access the customer database and automatically update the end user database.

Each end user file will consist of six datum; first name, last name, email address, cell phone number custom ID (such as employee number) and a password.

The reports tab is where the client administrator or customer will access reports generated by the end user from an accident scene.

The persons listed as emergency contacts will be notified when an accident report has been deployed. The emergency contact can log in to the reports page to view information as it develops by refreshing their browser window. From here they can also generate a PDF version of the report for download to their own computer. Accident reports will remain the property of the customer and may be kept on the servers for a five-year period. With this system the information is immediately accessible, and permanently stored, in the cloud, and available to the employer long after a driver (or user) leaves the company.

SUPER ADMINISTRATOR: Super administrators are representatives of the provider who have full access to all of the features and data within the system but do not, unless expressly granted, have access to the actual code base. Super administrators can manage all user accounts, customer accounts, and pricing packages to assist the customer as necessary. Super administrator is also the platform upon which the system templates are built.

Each template is comprised of questions that are arranged into sections. The order of the questions is governed by rules that are assigned by the super administrator to determine the output based on user input, or answers. In this way, the system is configurable to the specific wants and need of a client company.

A template can be designed for many different purposes. For example, a company that handles hazardous materials may want to use a template that would instruct a driver what to do in the event of a hazmat spill and contain prompts to contact the national hazmat hotline. A company that handles passenger transportation would use a template designed to assess the injury status of the passengers and collect their contact information.

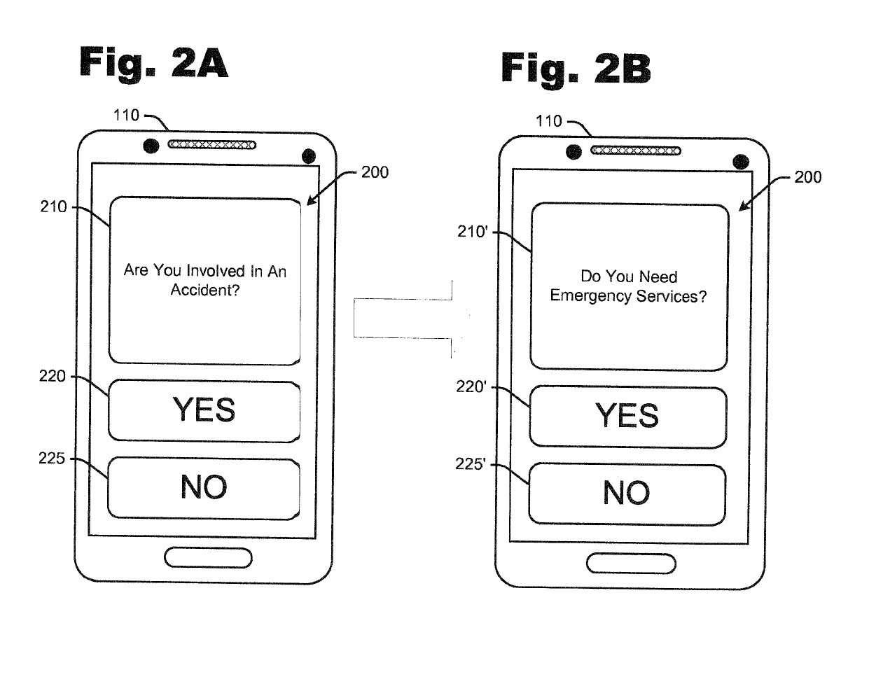

FIGS. 2A-B is are illustrations of example screen output by the mobile accident processing system and method, illustrating an initiator sequence. The screen output may be implemented at least in part using an end-user interface (e.g., a computing interface such as on a mobile device 110 and/or a web-based interface). In an example, the end-user is able to make predetermined selections, and the operations described herein are implemented to present results to a user. The user can then make further selections. It is also noted that various order of the operations described herein may be automated or partially automated by the computing system(s).

With reference to FIG. 2A, the screen output displays a question area 210 and an answer area (YES button 220 and NO button 225). The question area 210 asks the user “Are you involved in an accident?” The user may answer by selecting Yes button 220 or NO button 225. Based on the user interaction with the device 110, the program code may execute to enter an accident processing mode (e.g., as illustrated in FIG. 2B), or a training mode (not shown in FIG. 2A or 2B).

Commercial vehicle drivers may be required (e.g., by the company and/or government) to be trained in many topics, e.g., ranging from Hours of Service and Fatigue Management to Defensive Driving and FMCSA regulations. The training mode may include appropriate training by way of videos, instructional text, mock accident reporting, etc.

The training mode may also include training on accident procedure and behavior. The manner in which a driver conducts himself or herself at the scene of an accident scene may be used during investigation, and potentially later litigation and/or settlement discussions. Commercial drivers are often a distributed work force and bringing them into a classroom for training disrupts the workflow and consumes scarce resources in an industry typically operating on thin profit margins. Therefore, providing the training mode on a driver's mobile device enables the drivers to complete mandatory and/or optional training at the driver's convenience.

The accident processing mode may inquire whether user (or other party involved in the accident) needs or desires Emergency Services (e.g., police, fire, ambulance, towing service), as illustrated by question area 210′ in FIG. 2B. Again, the user may answer by selecting the appropriate YES button 220′ or NO button 225′. Based on the response to this and/or other questions, the program code may execute to automatically contact one or more appropriate emergency service directly based on user input, while providing location data and other information about the accident (e.g., from the device, the vehicle, and/or the driver or other user of the mobile device 110).

The accident processing mode also directs drivers on site and in real time (i.e., at the scene of an accident scene) to collect accurate, timely, and comprehensive information about the accident, by providing sequential questions and/or instruction to the driver, and receiving data input (e.g., text, photos, voice recording and/or video) at the mobile device. The ability to input this data and have it available instantaneously and/or at a later time by an administrator of the company, further enables production of a comprehensive accident report at the scene.

In an example system there may be eleven (11) question, information gathering, informational, etc. types and related user interface configurations:

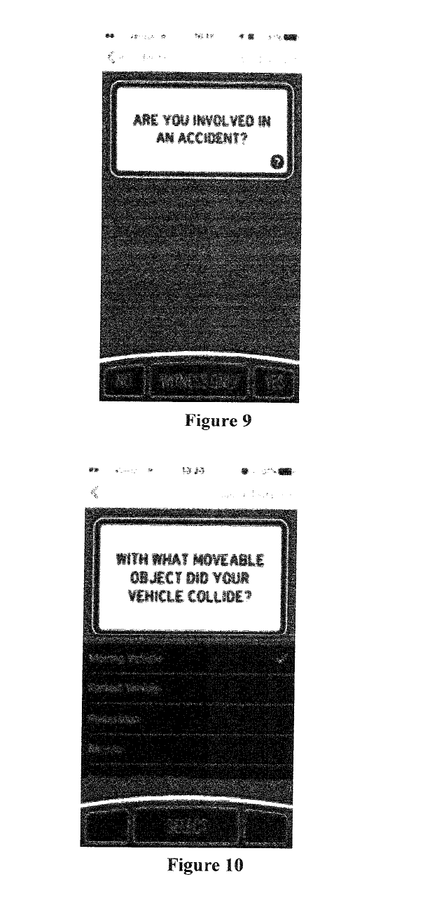

YES/NO/OTHER: This question returns one of three results from the user. The “OTHER” answer can be any short response chosen by the Super Admin such as “DON'T “KNOW” or WITNESS ONLY. An example of this type of question and user interface may be in form as shown in FIG. 9.

MULTIPLE CHOICE: This type of question returns a scroll down list of options from a comma separated values list within the question. This can be used where we want the end user to choose from a limited list of options, such as when determining the make of a vehicle. An example of this type of question and user interface may be in form as shown in FIG. 10.

NUMBER RANGE: This question returns a number answer from 1 to any number we choose. It is typically employed to determine how many vehicles are in an accident or how many passengers in a vehicle. An example of this type of question and user interface may be in form as shown in FIG. 11.

DIAGRAM: A diagram question instructs the user to select a road diagram that most closely represents the current road type. Subsequently the user places arrows representing the vehicles on the diagram indicating their position during the accident. Vehicle representations can be moved with a finger gesture and rotated via arrow controls. An example of this type of question and user interface may be in form as shown in FIG. 12.

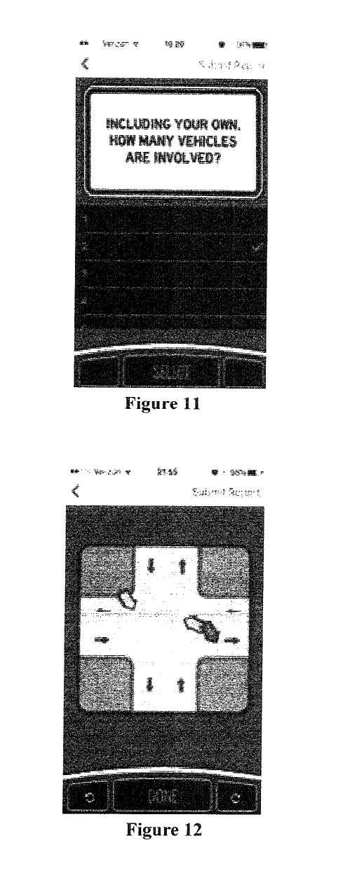

INFORMATIONAL: This question does not return an answer, but requires a single input from the user. It is designed to provide instruction to the user and captures their acknowledgement of the instruction. An example of this type of question and user interface may be in form as shown in FIG. 13.

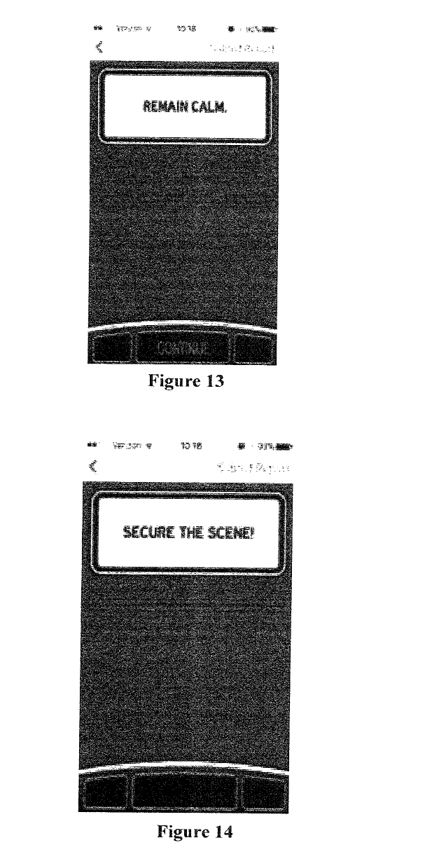

SLIDE SHOW: A slide show is a series of instructions designed to play through to completion without the input of the user. It is used to provide quick instructions to the user in an urgent situation. An example of this type of question and user interface may be in form as shown in FIG. 14.

IMAGE: An image question instructs the user what pictures to take and how to take them. Photos are immediately transferred to the report engine on the network as long as connectivity is present. In the event that there is no connectivity, the images are stored on the device until a connection is established, then transferred to the server. An example of this type of question and user interface may be in form as shown in FIG. 15.

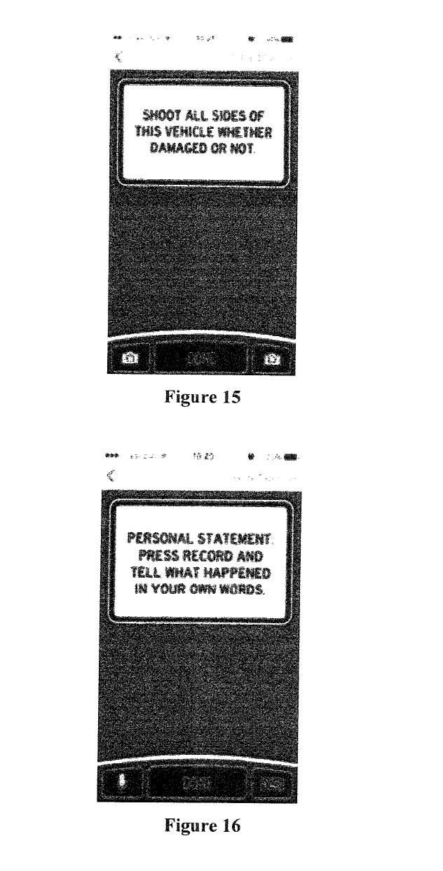

VOICE RECORDING: A voice-recording question allows the user to gather information about the situation that does not warrant a photo such as a witness statement or the contact information about another driver. It is also used to collect the statement from the end user. An example of this type of question and user interface may be in form as shown in FIG. 16.

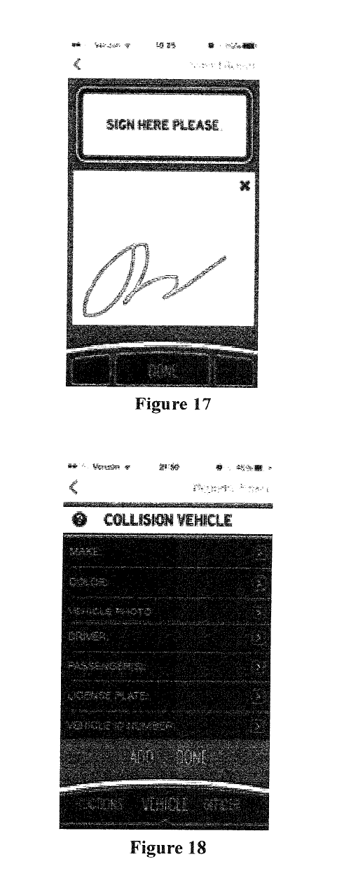

SIGNATURE: A signature type question allows the end user to finger sign a box indicating the accuracy of the report and exports the signature as a JPEG file. An example of this type of question and user interface may be in form as shown in FIG. 17.

PAGE/PAGE GROUP: The Page and Page Group questions work together to provide an efficient way to organize the Gather Information section so that the user is able to scroll quickly between relevant topics for which information needs to be gathered. It is in this way that the user is able to rapidly process and organize information in a non-linear fashion from a scene that may be chaotic and disorganized.

The Page Group question acts as a container of sorts for the Page Questions. It is noticeable to the user insofar as the screen becomes arranged as a group of question lists that scroll to the left and right using a horizontal finger swipe gesture to navigate between lists.

The relationship between the Page Group and Page question can be thought of as that of a filing cabinet to a drawer within the cabinet. Within the Page question can be filed any other questions that might be relevant.

In the example in FIG. 18, VEHICLE is the Page question within the Page Group; as is the OFFICER question on the right and the INSTRUCTIONS question partly visible on the left. The list of questions such as MAKE, COLOR and VEHICLE PHOTO become subordinate to the PAGE question or, files within the drawer. The user selects the appropriate PAGE question by swiping to the left or right.

In an example system, the behavior of the questions/user interfaces is governed by rules. Rules identify conditions based on answers provided by the end user and cause the application to affect certain behavior. A rule can be invoked for any answer to any question type.

REDIRECT: This rule simply tells the application to load the next question based on the answer given by the end user. For example, answering yes to the question “ARE YOU INVOLVED IN AN ACCIDENT?” will immediately redirect to the question “HAVE YOU ALREADY CALLED 911?”. A no answer will load the secondary assessment option questions. The redirect rule is required in order for the question to advance.

SEARCH: The search rule causes the device to open a web browser and search the Internet for a pre-determined term query. For example, a yes answer to the question “DO YOU NEED TO FIND A WRECKER?” would search for the term “heavy duty tow trucks near me” and would return the result to the end user. The search term is predetermined by the configuration controlled by the super administrator.

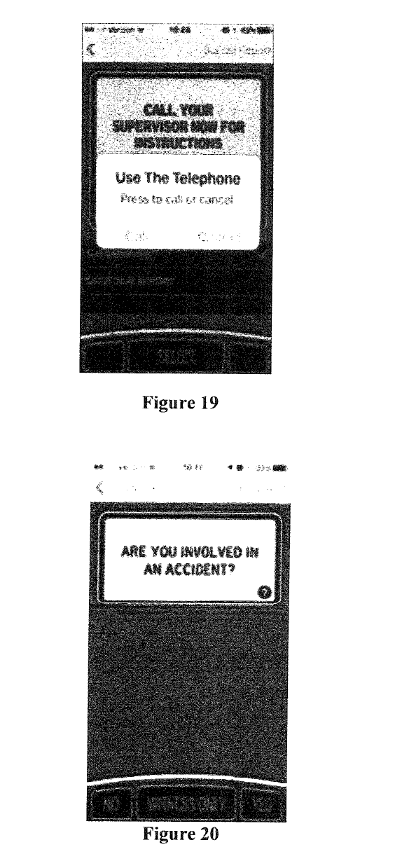

TELEPHONE: Like the Search rule, the Telephone rule access the phone function of the device and calls a predetermined number installed by the super administrator. This is useful for directing the end user to call 911 for emergency services, the National Hazmat Response Line, or other telephone number. An example of this type of question and user interface may be in form as shown in FIG. 19.

NOTIFICATION: As mentioned above, when the Client Administrator establishes their account in the Client Portal, they will create a list of persons whom should be notified when a User deploys an accident report and whether they should be notified by text message, email or both. The Notification rule causes such notification to be sent with a message pre-determined by the rule itself. An example of this type of question and user interface may be in form as shown in FIG. 20.

In this example, when the User answers YES, a message is sent with the user's name in the subject line stating that the above named driver has been involved in an accident with instructions for logging into their account in order to receive updates.

CREATE REPORT: This rule commands the server side program to begin compiling data from the client side application. Without this rule, the report will not be created and some other rules will not function.

FOLLOW NEXT: This rule serves as an IF/THEN statement by testing the condition of a previous answer, then commanding the application to follow a different logic branch depending on that answer.

SUBMIT REPORT: This rule sends commands to submit all data to the server in the form of the accident report as well as commanding the client side application to purge the memory of the device.

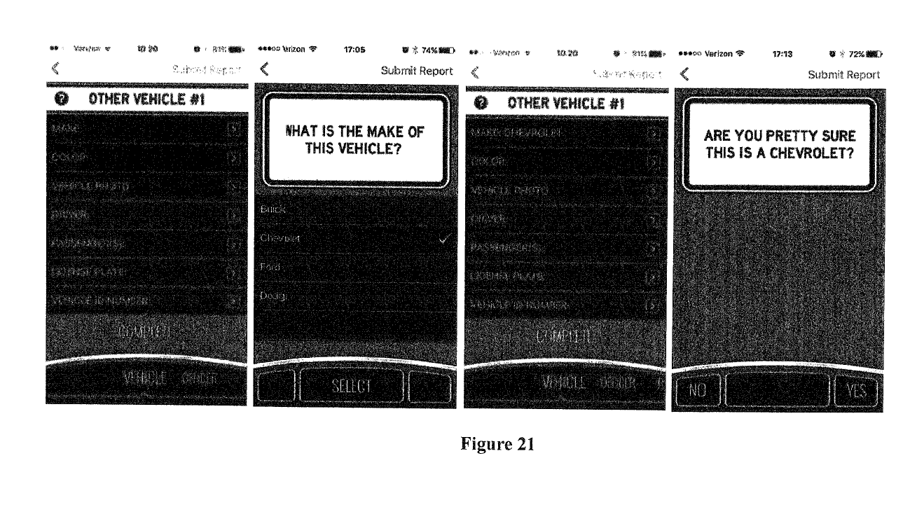

ENABLE/DISABLE: This is a very useful rule when working in the Page and Page Group type of question as it allows these questions to be enabled or disabled at will as shown in FIG. 21.

In the first panel of FIG. 21, “MAKE” is a Page Group question that is enabled by default. This leads to the Multiple Choice question,” WHAT IS THE MAKE OF THIS VEHICLE? When the condition “Chevrolet” is selected, the rule to disable the “MAKE” question is applied while simultaneously enabling the “MAKE: CHEVROLET” question as well as the ‘ARE YOU PRETTY SURE THIS IS A CHEVROLET?” QUESTION. The use of this rule allows an incredible range of functionality that allows the application and system to be adapted to nearly any accident scenario.

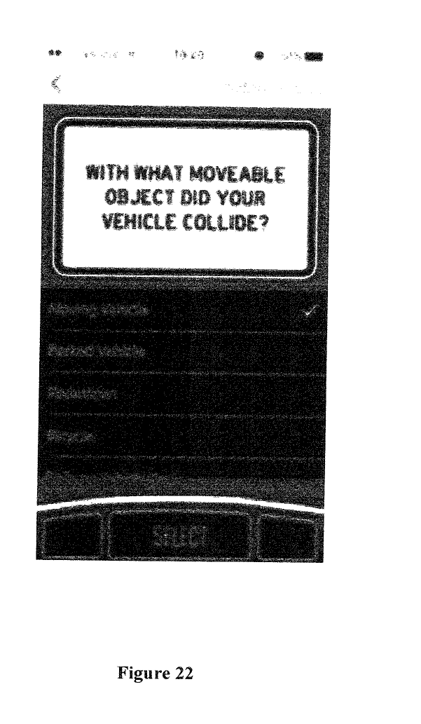

In this example as shown in FIG. 22, selecting the MOVING VEHICLE option will enable a series of questions related to a moving vehicle collision and maybe disabling the grouping of questions related to pedestrians. Selecting the “PEDESTRIAN” option enables a grouping of questions related to a pedestrian collision, and maybe disabling questions about a moving vehicle.

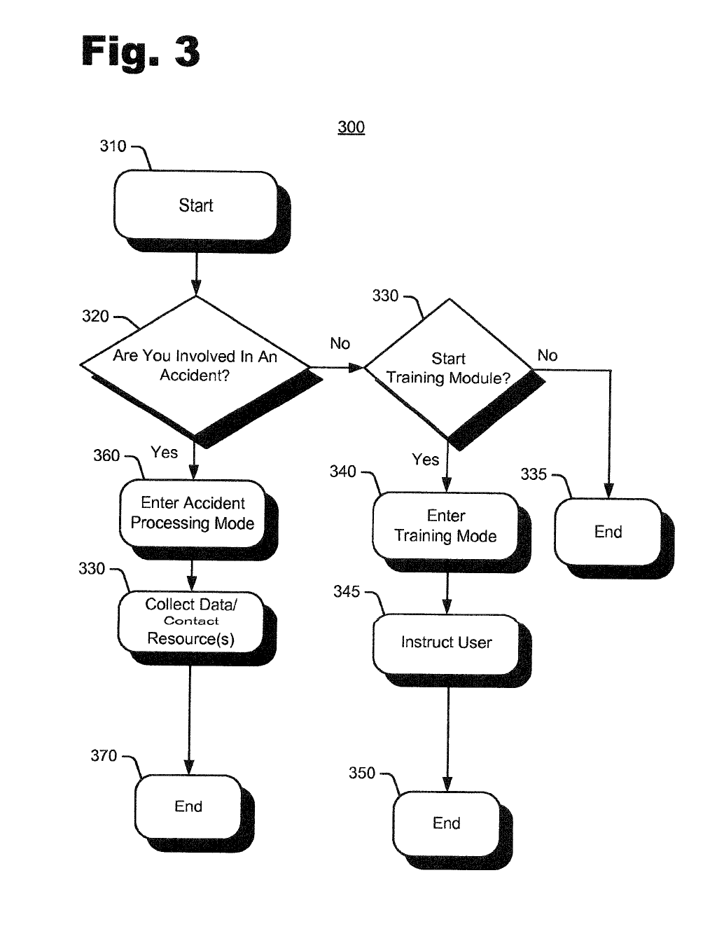

The accident processing mode and training mode may be better understood with reference to the example operations shown in FIG. 3. FIG. 3 is a flowchart illustrating example operations 300 to initiate accident processing and a training module for accident processing.

Operations to capture data, move data between data fields, and process the data and generate output may be embodied as logic instructions on one or more computer-readable medium (e.g., on the mobile device 110 and/or host 120). When executed on a processor, the logic instructions cause a general purpose computing device to be programmed as a special-purpose machine that implements the described operations. In an example, the components and connections depicted in the figures may be used.

In operation 310, the operations start and may then proceed to ask the user whether they have been involved in an accident or desire to enter the training mode at operation 320. If the user has not been involved in an accident, then the operations may inquire whether the user desires to execute the training module at operation 330. If the user does not want to enter the training module (e.g., the application has been opened by mistake), then operations may end at 335.

If the user selects to enter the training module, then the mobile device 110 may enter training mode at operation 340. Training mode may include providing instruction to the user at operation 345, e.g., in the form of video, audio, text, interactive modules, and/or otherwise presenting the user with suitable training information (e.g., that which is required by the company and/or government, and/or that which is optional). Following presentation of the training material, the operations may end at operation 350.

If the user has initiated the accident processing module (e.g., by answering the question at operation 320), then the mobile device 110 may enter the accident processing mode at operation 360. In the accident processing mode, the mobile device 110 may be configured to collect data from the user and/or interact with remote sources (e.g., instructional material, a human operator, a company administrator, and/or emergency service(s)). Following operation in the accident processing mode, the operations may end at operation 370. It is noted that although operations on the mobile device 110 may end, operations may continue at the commercial carrier facility 105 (e.g., on host 120), including but not limited to continued processing.

For purposes of illustration, the training module and/or accident processing module may include any of a wide variety of resources. For example, either module may include instructional resources that the user may view (e.g., a video) that may be a tutorial or instructional recording. The educational module may take the user through an instructional session aimed at informing the driver of operational protocol to be followed in the case of an accident, safety training, etc.

In an example, the user may be instructed how to behave (behavioral information) in the case of an accident. For example, being courteous and respectful, never engaging in an argument, only speaking with law enforcement, being careful of wording during conversations, and making sure to complete the accident report before leaving the scene. The driver may be instructed for instance to stop in a safe spot, survey the area for power lines and/or other safety concerns, make sure the vehicle and any persons are visible on the roadway, and how to initiate a call for help.

In an example, the user may be instructed how to conduct a primary assessment (e.g., is an ambulance needed) and secure the accident scene, including but not limited to how to contain or control the incident by placing hazard triangle signs, assessing injury severity, and administering help (e.g., only to the level of that emergency first aid is required).

In an example, the user may be instructed how to conduct a secondary assessment, answering any questions queried by the application program on the mobile device, how to document the accident scene including driver or witness information, vehicle information, statement collection, and photographs that to acquire. Instruction may include otherwise unintuitive actions, such as to make sure to capture all of the accident scene, even if it is incriminating because other people or parties on the scene may be capturing these images or ideas and having their own photos will help better assess or cast a different light on the accident scene. Instructions may also include what not to document and driver misconceptions including failing to document parts of the scene because they may seem incriminating. Finally, the user may be prompted to perform a review to make sure the report is complete, and identify what if any next steps should be taken, and information including what to expect following the accident (e.g., any impairment testing and/or questions that may arise during the investigation phase).

The operations shown and described herein are provided to illustrate example implementations. It is noted that the operations are not limited to the ordering shown. Still other operations may also be implemented.

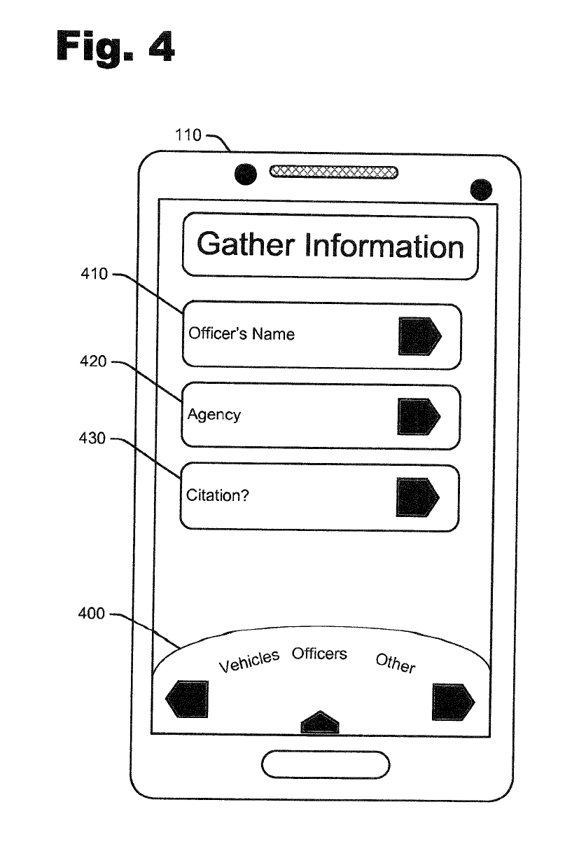

FIG. 4 is an illustration of an example screen output by the mobile accident processing system and method, illustrating an example aspect of accident processing. In an example, the accident processing module may enter a secondary assessment mode. A series of questions are posed to the user, some of which may require input in order to create an internal accident report.

The mobile accident processing system and method enable the user to select various options for gathering information, e.g., using a selection wheel 400. In the example shown in FIG. 4, the user has selected “Officers” and so the questions are shown illustrating “Officer's Name 410,” “Agency 420,” “Citation? 430.” Selecting any one of these may cause the user to be prompted for corresponding information. For example, data collection may include the name, agency, business card or other identifying registration number for the officer(s) or law enforcement at the scene. If no citation information was entered earlier or an “I don't know” response was entered, the program code may prompt the user for citation information.

Other questions may include asking the user how many vehicles are involved in the crash, if a tow truck is required for any vehicle, and if the driver is being cited or issued a citation by a law enforcement authority. If a tow truck is required the user may be reminded not to start the engine of the vehicle (thus maintaining the integrity of the “black box” in the vehicle). Still other categories may be displayed on the selection wheel 400, and other questions may be posed to the user to gather the appropriate information.

Other examples of data entry may include a prompt to the user to take a photograph of the license plates of the vehicle(s), data entry screens for driver's and/or witnesses of the accident. As shown this data may be entered as text, voice recording, and/or photograph.

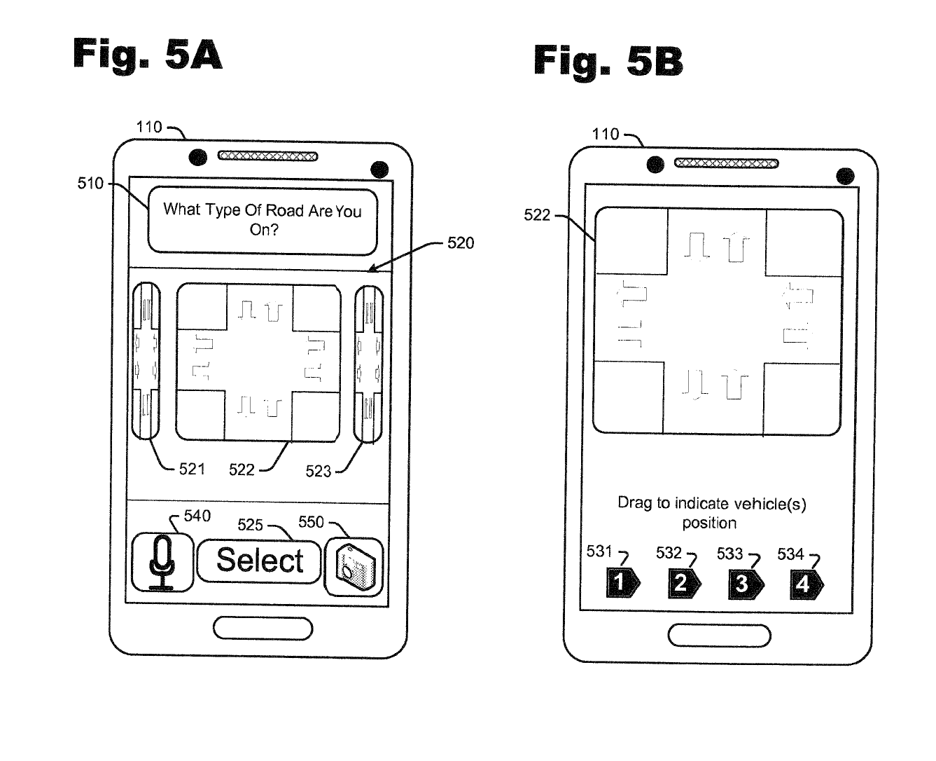

Other data entry screens include diagramming the accident, including vehicles and other aspects of the scene. FIGS. 5A-B is are illustrations of example screen output by the mobile accident processing system and method, illustrating another example aspect of accident processing. In the example shown in FIG. 5A, the mobile accident processing system and method prompts the user to select the type of roadway, e.g., by asking question 510 and providing a sliding window 520 with different roadway types 521, 522, and 523 to select from. The user may scroll between the different roadway types 521523 (and/or others) and make a selection, e.g., with button 525. As illustrated in FIG. 5B, the user has selected roadway type 522. The user is then prompted to drag icons 531-534 onto the roadway to indicate vehicle positions, thereby diagramming the accident scene.

In an example, the series screens may further request the user to input data (or make appropriate selections) about the scene of the accident such as surface type, road type, surface conditions, and traffic conditions. These screens may also prompt the user to take photos of the scene. The user may make a voice recording (e.g., by selecting microphone option 540 in FIG. 5A) and/or take photos of the accident scene (e.g., by selecting camera option 550 in FIG. 5A).

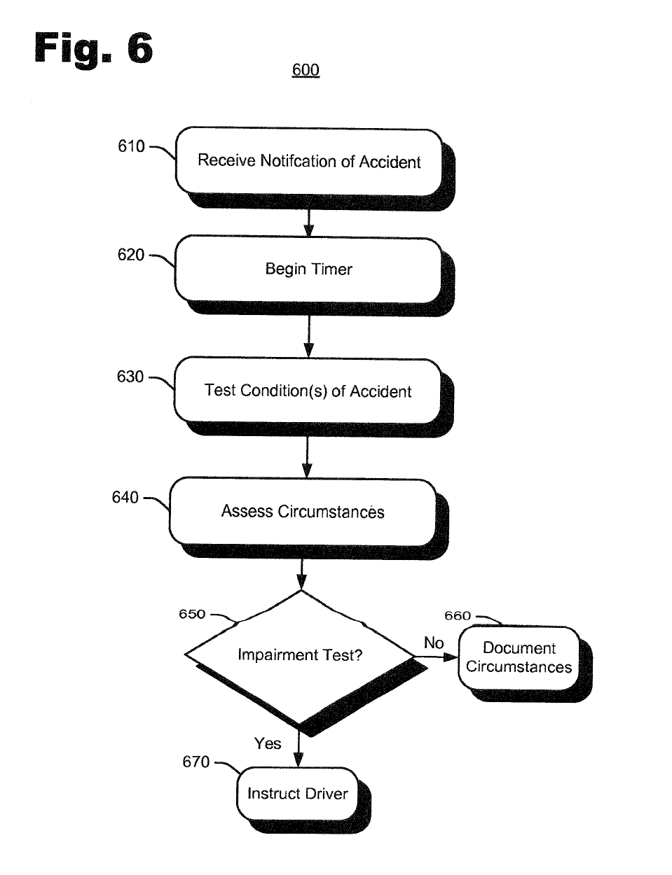

It should be noted that the screenshots of FIGS. 2A-B, 4, and 5A-B are shown only for purposes of illustration, and are not intended to be limiting. Input/output may be generated in any suitable format(s). Nor are these screenshots intended to show all possible input/output displays generated by the program code. In addition, input/output may be displayed at the user device (e.g., mobile device 110) and/or an administrator (e.g., host 120), as will be readily understood by those having ordinary skill in the art after becoming familiar with the teachings herein. Various non-limiting examples of such data are described for purposes of illustration following the description of the logic module shown in FIG. 6.

FIG. 6 is a flowchart illustrating example operations 600 of a logic module to test for conditions and assess circumstances following an accident in which a driver may be subject to an impairment test.

Under certain circumstances following an accident a driver must be subject to an impairment test (e.g., an alcohol test within eight hours of the accident and a drug test within 32 hours post-accident). If the company cannot achieve this, then they must document efforts to have done so.

The conditions for a drug and alcohol test requirement are; if there has been any fatality; if there has been an injury requiring treatment away from the scene (ambulance ride) and the driver has received a traffic citation; or any vehicle is required to be towed from the scene and the driver receives a citation.

The mobile accident processing system and method tests for these conditions and assists the administrator to accomplish the goals by accessing the contact information that has previously been stored in the clients database and conducting a search for drug testing facilities. The mobile accident processing system and method also documents those efforts (e.g., in order to satisfy the testing requirements under 49 CFR 383.303).

In operation 610, the program code receives notification of an accident. The program code receiving notification may be executing on the mobile device 110 and/or at the host 120. In operation 620, a timer is started. The timer may be set based on internal policy and/or government laws, rules or regulations, or on any other standard or benchmark. In an example, the timer is initiated based on an alcohol test to be performed within eight hours of the accident and a drug test within 32 hours post-accident.

In operation 630, the mobile accident processing system and method tests at least one condition of the accident. In operation 640, the mobile accident processing system and method assesses the circumstances of the accident. Assessing the circumstances may be based on data gathered and processed by the program code and may include by way of illustration determining whether at least one of Conditions 1-3 are satisfied:
Condition 1: the accident involves a fatality;
Condition 2: if there has been an injury requiring treatment away from the scene (e.g., an ambulance ride), and a traffic citation is issued to a commercial carrier driver; or
Condition 3: a vehicle is required to be towed and a traffic citation is issued to a commercial carrier driver.

Mathematically, the condition test can be expressed as (Fatality=Impairment Test) OR (Citation+Ambulance=Impairment Test) OR (Citation+Tow Truck=Impairment Test).

If one of three conditions is satisfied, then an impairment test is required. Additionally, the logic sequence not only applies to impairment testing, but also to suggest the preservation of the black-box data to aid in accident investigation and reconstruction. In other words, if the requirement for the impairment test is true, then the administrator also knows that there is a more serious situation on their hands. As such, they might want to have their vehicle towed, even if it is roadworthy, in order to not overwrite the black-box engine data. The company's alert level should increase based on this information and some large operators might even scramble a response team to the scene.

In operation 650, a determination is made whether an impairment test is needed and/or whether it can be completed. If the impairment test is not needed and/or cannot be completed, then the mobile accident processing system and method documents circumstances (e.g., that the driver indicated at least one condition was not satisfied).

In operation 660, the mobile accident processing system and method may instruct the driver to obtain impairment testing. For example, the user may be provided a location of the nearest test facility (e.g., based on location of user from a GPS link). In addition, an administrator of the commercial carrier company may be notified or contacted automatically with this information. Reminders may be issued until the user, administrator, or other inputs a code or otherwise indicates that the testing has been completed.

### EXAMPLES

The following examples are provided to illustrate various aspects disclosed herein. These examples are not intended to be limiting in any manner.

### Example 1

In a first example, the accident processing module is activated by the driver and/or by an involved party in the accident (e.g., a witness). Upon activation of the accident processing module, the host (e.g., computing device(s) 120 at the commercial carrier facility 105) is contacted to begin processing the accident on the host-end.

In addition, the user is prompted whether there is a need for emergency services 207. An input of “yes” may prompt a screen to access communication to emergency services and/or contact the appropriate emergency services directly. The accident processing module may also prompt input of other data related to the emergency services (e.g., severity of injury, whether traffic is blocked by the vehicles).

A global positioning satellite (GPS) communication system may be activated to obtain location, heading, and weather data. This information may be processed, stored, and/or communicated to various parties at various points during execution of the program code. For example, location and other GPS data obtained from communication with a GPS, cellular telephone triangulation or other method or system, may be relayed to a network based search engine to find the nearest local law enforcement and/or other emergency services to automatically contact and request assistance from these services based on processing the input by the user.

The program code may continue by prompting the user to collect data related to the accident (e.g., injury of persons, location of vehicle, and property damage). This data may be processed at least in part on the mobile device 110 and/or transmitted to the host 120 for simultaneous and/or later processing (e.g., to generate an internal accident report). Processing the data may also be used to initiate a timer and notify the driver to undergo impairment testing.

### Example 2

In an example where there is an injury on the scene, the accident processing module may enter a primary assessment mode to assist the user in securing the scene. This mode may direct the user to secure the scene by turning flashers on, turning engine off, putting warning triangles out, assisting those in need (as appropriate), remaining calm, reminding the user not to move injured people, prevent further accidents, and cooperate with authorities. All input by the user may be logged in this mode and becomes part of an internal accident report generated by the program code. Further reminders may also be provided to the user, e.g., as to important items to remember for the next step of the process, including for example to discuss the accident only with authorities, remembering to not discuss fault with anyone, and only explaining what happened in the accident.

### Example 3

In an example, the accident processing module may enter a secondary assessment mode. A series of questions are posed to the user, some of which may require input in order to create an internal accident report. These questions may include asking the user how many vehicles are involved in the crash, if a tow truck is required for any vehicle, and if the driver is being cited or issued a citation by a law enforcement authority. If a tow truck is required the user may be reminded not to start the engine of the vehicle (thus maintaining the integrity of the “black box” in the vehicle).

In an example, data collection may include the name, agency, business card or other identifying registration number for the officer(s) or law enforcement at the scene. If no citation information was entered earlier or an “I don't know” response was entered, the program code may prompt the user for citation information. Other data may include vehicle, driver and passenger information. Screens may prompt the user to take a photo of the person's driver's license, ask about injury and/or fatality information, and/or if that person gave a statement to law enforcement officers on the scene.

Vehicle information may be entered as to make, model, year, color, license plate number, damage, and user may be prompted to take a photograph with the mobile device running the application or other photographing means.

A data entry field may be displayed for the user to enter his or her own statement. This may be entered via text entry, voice recordation or video. Other persons at the scene and witness information may also be captured.

Other examples of data entry may include a prompt to the user to take a photograph of the license plates of the vehicle(s), data entry screens for driver's and/or witnesses of the accident. As shown this data may be entered as text, voice recording, and/or photograph. Any voice recordings may be translated to text by the program for final report creation. Other data entry screens include diagramming the accident, including vehicles and other aspects of the scene. The series screens have the user input data about the scene of the accident such as surface type, road type, surface conditions, and traffic conditions. These screens may also prompt the user to create a diagram of the accident and take photos of the scene.

The program code may enter a confirmation mode, which prompts the user to enter information missing in fields from earlier phases.

Directions may be provided to the user of next steps that need to be taken for instance in the case where an alcohol or drug test is required.

After these steps are successfully completed, the program code processes the data, e.g., by reconciling all answers, and creating an internal accident report. The data may be processed on the mobile device 110 and/or on the host 120.

### Example 4

In an example, the accident processing module may assess circumstances to determine whether an impairment test may be required. For example, a YES response to one or more questions (e.g., whether there are fatalities, a need for ambulance, need for towing vehicle, being issued a citation) may activate a timer and notify the user that an impairment test (e.g., drug and/or alcohol test) may be required. The module may further provide a location of the nearest test facility (e.g., based on location of user from a GPS link). In addition, an administrator of the commercial carrier company may be notified or contacted automatically with this information. Reminders may be issued until the user, administrator, or other inputs a code or otherwise indicates that the testing has been completed.

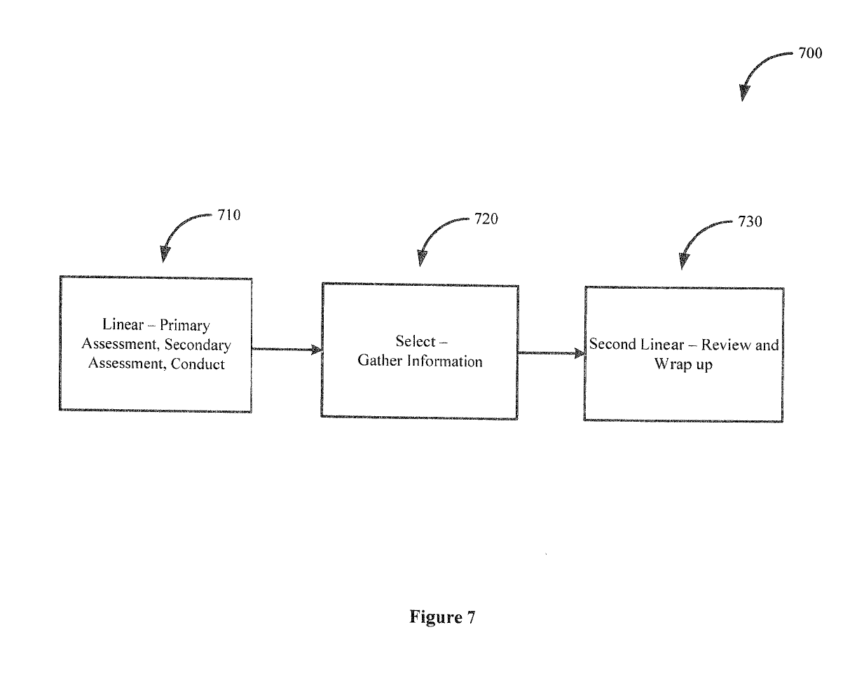

FIG. 7 shows an example flowchart of a system and method for a mobile accident reporting 700. Method 700 includes a linear portion 710, a select portion 720, and a second linear portion 730. Linear portion 710 may include a primary assessment, a secondary assessment, and a conduct portion. Each portion includes logical groups of questions/data gathering/information/user interfaces, etc. for various situations of an accident and accident scene and reporting. Certain groups will be presented to the user depending on answers to previous questions or information received from the user about the accident.

In an example accident reporting system, the primary assessment includes groups such as conduct reminders, major emergency, primary assessment, secondary assessment, and secure the scene.

The select portion 720 may include non-linear groups such as bicycle, bridge, building/wall, cargo loss, collision vehicle 1, collision vehicle 2, collision vehicle 3, collision vehicle 4, crash, driver 1, driver 2, driver 3, driver 4, driver grouping, falling cargo, falling object, fence, fire, fire hydrant, immersion, jackknife, jumped from vehicle, law enforcement, live animal, mailbox, make, moving vehicle, other fixed object, other non-collision, other non-fixed object, overturn, parked vehicle, passenger, pedestrian, pole/post, roadside feature, scene, traffic barrier, train, tee, type, witness, work zone equipment. Each of these may have a series or set of questions/information gathering/user interfaces for collecting information about the accident.

The second liner portion may include groups such as drug test, review and wrap up, and submit. The groups have questions/information gathering/user interfaces generally related to the name of the group. It will be appreciated that these groups may be in other orders, or by themselves.

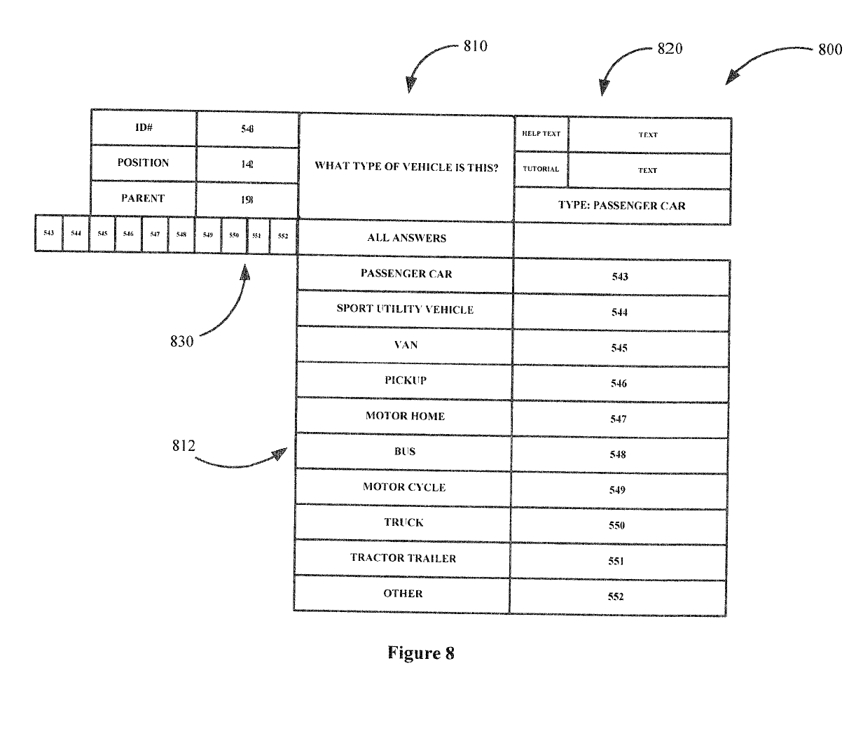

FIG. 8 is an example logic operation chart 800 of the selection of a type of vehicle user interface. Chart 800 may include a question/input portion 810, a selected portion 820, and a disabled portion 830. Portion 810 may include a selections portion 812, which may include suggested selections with which to answer the prompt of the question/input portion 810.

In this example, the question portion 810 includes a prompt for “What type of vehicle is this?” The selection portion 812 may include various suggestions for the type of the vehicle. In this example, passenger car (ID# 543) has been selected as shown in the selected portion 820. This selection then disables the vehicle types shown in the disabled section 830, such that more than one type of vehicle may no be selected.

It is noted that the examples shown and described are provided for purposes of illustration and are not intended to be limiting. Still other examples are also contemplated.

1. A non-volatile computer-readable medium having stored thereon instruction, which if executed by a processor, cause the processor to:
receive notification of an accident involving at least a vehicle;
present questions or information requests to the user regarding the accident; and
guide a user through a process of collecting information about the accident at least in part using the questions or information requests, wherein the guiding comprises a series of questions or information requests, and wherein at least one of a subsequent one of the series of questions or information requests is based on a response to a previous question or information request.

2. The computer-readable medium of claim 1, comprising further instructions, which cause the processor to:
receive information from a global positioning device; and
associate at least one location-specific condition with the circumstances.

3. The computer program product of claim 2, wherein the at least one location-specific condition is one of a weather condition, a road condition, and a traffic condition.

4. The computer readable medium of claim 1, comprising further instructions, which cause the processor to instruct a user on a step-by-step basis to collect information about the accident.

5. The computer readable medium of claim 1, comprising further instructions, which cause the processor to create an accident report using at least a portion of the collected information.

6. The computer-readable medium of claim 1 wherein the collected information comprises if at least one of the following conditions exist:
Condition 1: the accident involves a fatality;
Condition 2: if there has been an injury requiring treatment away from the scene (e.g., an ambulance ride), and a traffic citation is issued to a driver; and
Condition 3: a vehicle is required to be towed, and a traffic citation is issued to a driver.

7. The computer readable medium of claim 6, wherein impairment testing is required and a user is instructed to preserve black box data if at least one of the conditions 1-3 exist.

8. The computer readable medium of claim 1, comprising further instructions, which cause the processor to facilitate a user contacting emergency personnel, based at least on the collected information.

9. The computer readable medium of claim 1, comprising further instructions, which cause the processor to provide a notice to a predetermined contact of the received notification.

10. A mobile accident processing system, comprising:
a user device configured to receive notification of an accident involving at least a vehicle; present questions or information requests to the user regarding the accident; and guide a user through a process of collecting information about the accident, wherein the guiding comprises a series of questions, wherein at least one of a subsequent one of the series of questions is based on a response to a previous question or information request, and issue a notification of an accident involving at least a vehicle; and
a base station device configured to receive the notification from the user device and send a second notification to predetermined contacts.

11. The mobile accident processing system of claim 10, wherein a plurality of the series of questions are logically grouped together.

12. The mobile accident processing system of claim 10, wherein the collected information comprises pictures.

13. The mobile accident processing system of claim 10, wherein the collected information comprises a voice recording.

14. The mobile accident processing system of claim 10, wherein the user device is further configured to provide instructions to a user to secure the scene of the accident.

15. The mobile accident processing system of claim 10, wherein the user device is further configured to provide training material and quizzes.

16. The mobile accident processing system of claim 10, wherein the user device is further configured to provide behavioral instructions to a user.

17. The mobile accident processing system of claim 10, wherein the user device is configured to instruct a user on a step-by-step basis to collect information about the accident at least in part using the questions or information requests.

18. A mobile accident processing method, comprising:
issuing, by a user device, a notification of an accident involving a vehicle;
guiding, by the user device, a user through a process of collecting information about the accident at least in part using the questions or information requests, wherein the guiding comprises a series of questions or information requests, and wherein at least one of a subsequent one of the series of questions or information requests is based on a response to a previous question or information request,
responding to the notification at a base station by sending out a second notification of the notification to predetermined contacts.

19. The method of claim 18, further comprising creating an accident report using at least a portion of the collected information by the user device or the base station.

20. The method of claim 19, wherein the report comprises at least one of a voice recording, a video, or a photograph.
